(19) United States
(12) Patent Application Publication
(10) Pub. No.: US 2013/0016043 A1
(43) Pub. Date: Jan. 17, 2013

(54) USER DEFINABLE KEYBOARD AND METHOD

(71) Applicant: QIANG YOU, Shenzhen City (CN)

(72) Inventor: QIANG YOU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/217,275

(22) Filed: Aug. 25, 2011

(30) Foreign Application Priority Data
Jul. 12, 2011 (CN) 201110194535.3

(51) Int. Cl. G06F 3/02

(52) U.S. Cl. 345/170

(57) ABSTRACT

The disclosure provides a user definable keyboard and a defining method adapted for the keyboard. The keyboard is connected to a computer and communicates with the computer, and the keyboard defines a plurality of keys and each key is associated with a backlight and a display unit. The method includes steps: receiving keyboard information from the computer, the keyboard information comprising key identifiers and key contents for defining a predetermined number of the keys; storing the keyboard information; illuminating with the backlight for each of the predetermined number of the keys according to the key identifiers; and controlling the display unit for each of the predetermined number of the keys to display a corresponding content according to the key contents.

### BACKGROUND

1. Technical Field

The disclosure relates to a keyboard and, more particularly, to a user definable keyboard and a defining method adapted for the keyboard.

2. Description of Related Art

A computer often employs a keyboard as an input device, and a position of each key is fixed on the keyboard and key information of each key is labeled on the keyboard. However, when a user wants to perform some special operations in the computer, such as playing a game, a special keyboard (e.g., a game keyboard) is provided for the special operations because the conventional keyboard cannot satisfy the needs for game playing.

Therefore, what is needed is a user definable keyboard to overcome the described shortcoming.

### BRIEF DESCRIPTION OF THE DRAWINGS

FIG. 1 is a block diagram of a user definable keyboard, in accordance with an exemplary embodiment.

FIG. 2 is a block diagram of a control unit of the user definable keyboard of FIG. 1.

FIG. 3 is a flowchart of a defining method adapted for the user definable keyboard of FIG. 1.

FIG. 4 is a first schematic diagram of the user definable keyboard of FIG. 1.

FIG. 5 is a second schematic diagram of the user definable keyboard of FIG. 1.

### DETAILED DESCRIPTION

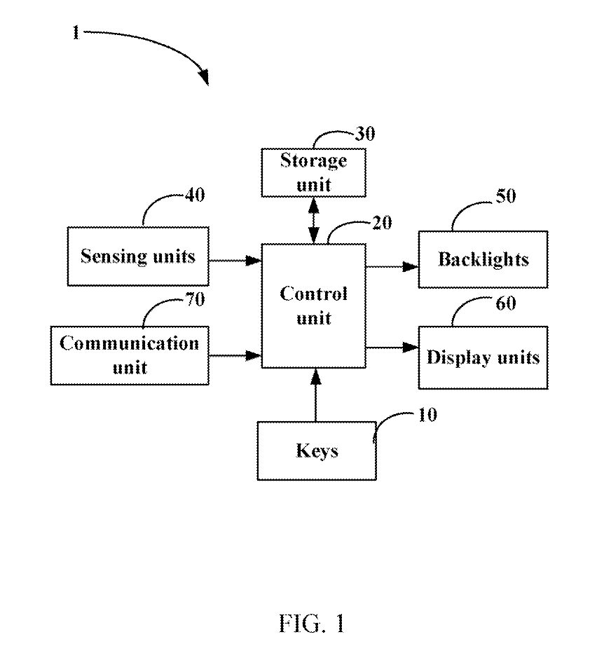

FIG. 1 is a block diagram of a user definable keyboard, in accordance with an exemplary embodiment. The user definable keyboard 1 is for being connected to a computer (not shown) and to communicate with the computer by wire or wirelessly. The user definable keyboard 1 is in a film shape and composed of a transparent flexible material. In the embodiment, the user definable keyboard 1 is composed of a transparent silica gel material.

The user definable keyboard 1 includes a number of keys 10, a control unit 20, a storage unit 30, a number of sensing units 40, a number of backlights 50, a number of display units 60, and a communication unit 70. Each of the number of keys 10 is associated with a corresponding one of the number of backlights 50 and a corresponding one of the number of display units 60. The backlight 50 emits light to light the corresponding display unit 60 to display information relative to the associated key 10. The communication unit 70 is connected to the computer and communicates with the computer. For example, when the user definable keyboard 1 is wirelessly connected to the computer, a battery (not shown) provides power for the user definable keyboard 1; and when the user definable keyboard 1 is connected to the computer by a wire, the computer provides power for the user definable keyboard 1.

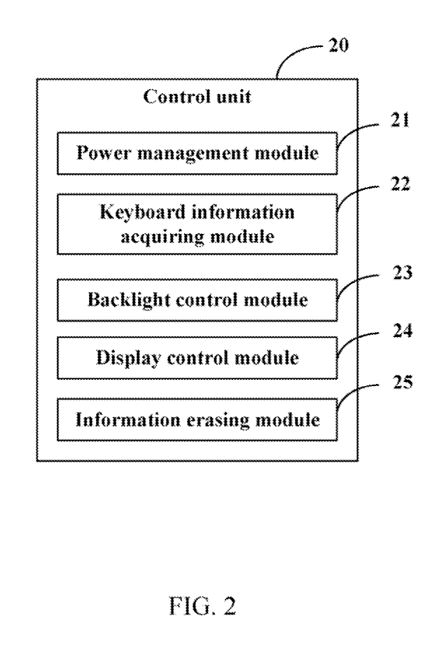

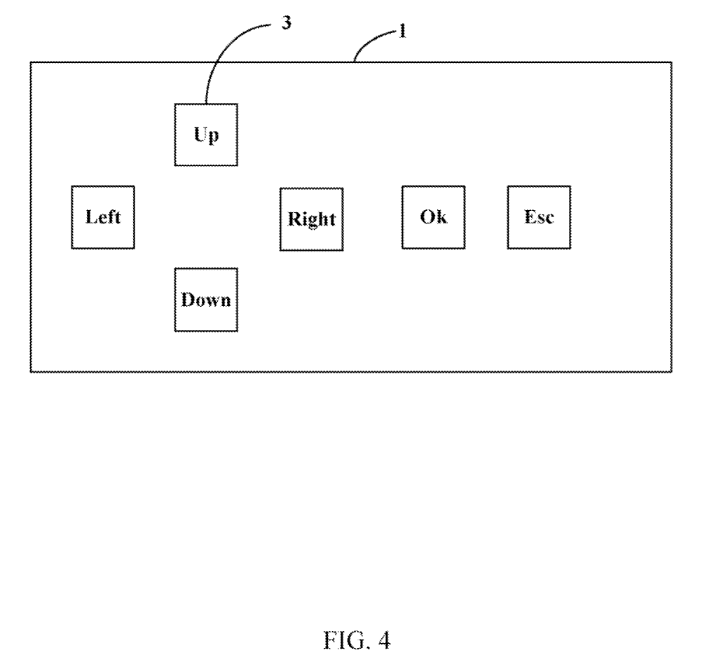

The control unit 20 is to control the user definable keyboard 1. As shown in FIG. 2, the control unit 20 further includes a keyboard information acquiring module 22, a backlight control module 23, and a display control module 24. The computer generates keyboard information in response to user inputs and transmits the keyboard information to the user definable keyboard 1. When the communication unit 70 receives the keyboard information from the computer, the keyboard information acquiring module 22 acquires the keyboard information. The keyboard information includes key identifiers and key contents for defining a predetermined number of the keys 10. Each of the key identifiers is for identifying a position of each of the predetermined number of the keys on the user definable keyboard 1 and each of the key contents is for defining a content of each of the predetermined number of the keys. For example, supposing that the keyboard information is for defining game keyboard information, that means, the user definable keyboard 1 is defined as a game keyboard, as shown in FIG. 4, the game keyboard is defined to include six keys, such as up key, ok key, left key, right key, down key, and esc key.

The storage unit 30 is to store the keyboard information. In the embodiment, the storage unit 30 is a static random-access memory. The backlight control module 23 illuminates with the backlight 50 for each of the predetermined number of the keys according to the key identifiers. The display control module 24 controls the display unit 60 for each of the predetermined number of the keys to display the corresponding content according to the key contents. For example, referring to the example described above again, that is, the user definable keyboard 1 is defined as the game keyboard. The backlight control module 23 illuminates with six backlights 50 on six positions corresponding to the six keys according to the key identifiers, and the display control module 24 controls six display units 60 to display six key contents on the six positions corresponding to the six keys according to the key contents. Thus, as shown in FIG. 4, a key content “up” is displayed on a first illuminated key position. A key content “down” is displayed on a second illuminated key position. A key content “ok” is displayed on a third illuminated key position. A key content “left” is displayed on a fourth illuminated key position. A key content “right” is displayed on a fifth illuminated key position. A key content “esc” is displayed on a sixth illuminated key position.

The user definable keyboard 1 further includes a number of sensing units 40. Each of the sensing units 40 is positioned under each key 10 and senses a pressure operation from a user. In the embodiment, the sensing unit 40 is a pressure sensor. When the user presses an illuminated key 10, the corresponding sensing unit 40 senses the pressure operation and generates a pressure signal, the communication unit 70 sends the pressure signal to the computer, and the computer performs a key function in response to the pressure signal.

The user definable keyboard 1 further includes a power management module 21 and an information erasing module 25. The power management module 21 controls the user definable keyboard 1 to turn on and turn off. When the power management module 21 turns on the user definable keyboard 1, the user definable keyboard 1 enters a work mode and responds to the user inputs. When the power management module 21 turns off the user definable keyboard 1, the user definable keyboard 1 does not respond to the user inputs.

When the power management module 21 turns off the user definable keyboard 1, the information erasing module 25 erases the keyboard information in the storage unit 30. In another embodiment, when the communication unit 70 receives the keyboard information from the computer again, the information erasing module 25 erases the keyboard information in the storage unit 30.

Therefore, the user definable keyboard 1 can be defined as many different keyboards according to the needs of the user. For example, when a new keyboard is to be defined, the user definable keyboard 1 can be turned off first, and thus the information erasing module 25 erases the keyboard information in the storage unit 30. When the user definable keyboard 1 is turned on again, the communication unit 70 receives new keyboard information from the computer and the user definable keyboard 1 displays new key contents on new illuminated positions according to the new keyboard information.

As shown in FIG. 4, the user definable keyboard 1 is defined as a game keyboard, the game keyboard illuminates six backlights 50 and displays six key contents on six key positions, therefore forming six game keys 3 of the game keyboard, such as up, down, left, right, ok, and esc keys.

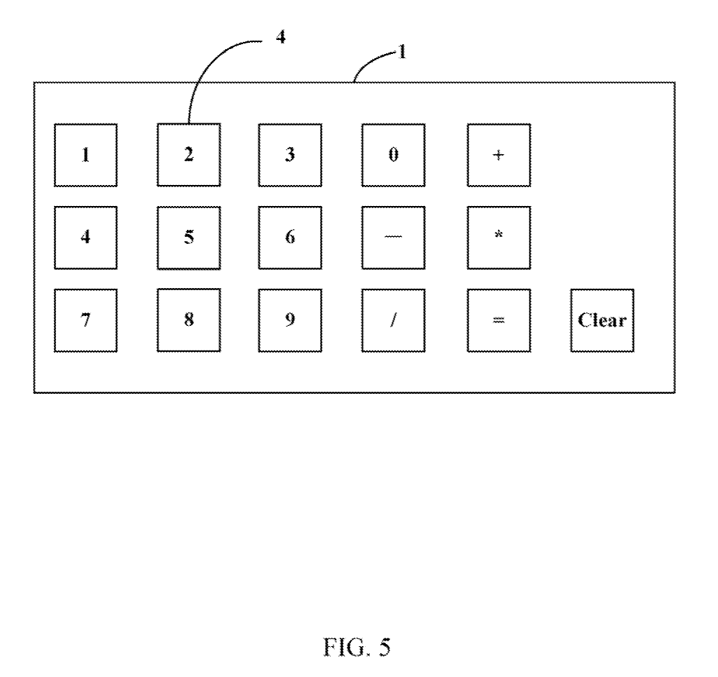

As shown in FIG. 5, the user definable keyboard 1 is a numeric keyboard, the numeric keyboard illuminates sixteen backlights 50 and displays sixteen key contents on sixteen key positions, therefore, forming sixteen numeric keys 4 of the numeric keyboard, the numeric keys 4 includes sixteen keys, such as 1, 2, 3, 4, 5, 6, 7, 8, 9, 0, +, −, *, /, =, and clear keys.

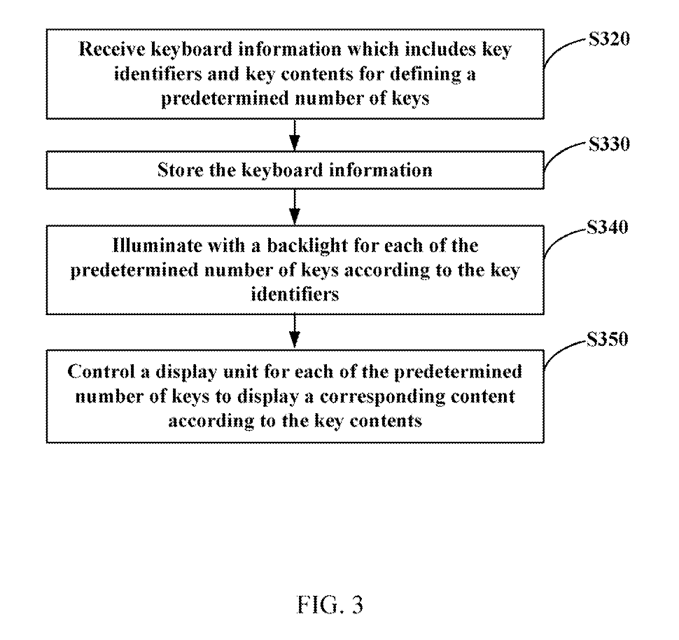

FIG. 3 is a flowchart of a defining method adapted for the user definable keyboard of FIG. 1. In step S320, the communication unit 70 receives the keyboard information from the computer and the keyboard information acquiring module 22 acquires the keyboard information. The keyboard information includes the key identifiers and the key contents for defining the predetermined number of keys. Each of the key identifiers identifies the position of each of the predetermined number of the keys on the user definable keyboard 1 and each of the key contents defines the corresponding content of each of the predetermined number of the keys. In step S330, the storage unit 30 stores the keyboard information. In step S340, the backlight control module 23 illuminates with the backlight 50 for each of the predetermined number of the keys according to the key identifiers. In step S350, the display control module 24 controls the display unit 60 for each of the predetermined number of the keys to display the content according to the key contents.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A user definable keyboard comprising:
a plurality of display units;
a plurality of backlights;
a plurality of keys, each key being associated with a corresponding one of the backlights and a corresponding one of the display units;
a communication unit, connected to a computer, to communicate with the computer;
a keyboard information acquiring module to acquire keyboard information when the communication unit receives the keyboard information from the computer, the keyboard information comprising key identifiers and key contents for defining a predetermined number of the keys, wherein each of the key identifiers is for identifying a position of each of the predetermined number of the keys on the user definable keyboard and each of the key contents is for defining a corresponding content of each of the predetermined number of the keys;
a storage unit to store the keyboard information;
a backlight control module to illuminate with the corresponding backlight for each of the predetermined number of the keys according to the key identifiers; and
a display control module to control the corresponding display unit for each of the predetermined number of the keys to display the corresponding content according to the key contents.

2. The user definable keyboard as recited in claim 1, wherein the user definable keyboard is in a film shape and composed of a transparent silica gel material.

3. The user definable keyboard as recited in claim 1, wherein the storage unit is a static random-access memory.

4. The user definable keyboard as recited in claim 1, further comprising a power management module and an information erasing module, wherein the power management module is to control the user definable keyboard to turn on and turn off, and when the power management module turns off the definable keyboard, the information erasing module is to erase the keyboard information in the storage unit.

5. The user definable keyboard as recited in claim 1, further comprising an information erasing module to erase the keyboard information in the storage unit when the communication unit receives the keyboard information from the computer again.

6. A defining method adapted for a keyboard, wherein the keyboard is connected to a computer and communicates with the computer, the keyboard comprises a plurality of backlights, a plurality of display units, and a plurality of keys, and each key is associated with a corresponding one of the backlights and a corresponding one of the display units, the method comprising:
receiving keyboard information from the computer, the keyboard information comprising key identifiers and key contents for defining a predetermined number of the keys, wherein each of the key identifiers is for identifying a position of each of the predetermined number of the keys on the user definable keyboard and each of the key contents is for defining a content of each of the predetermined number of the keys;
storing the keyboard information;
illuminating with the backlight for each of the predetermined number of the keys according to the key identifiers; and
controlling the display unit for each of the predetermined number of the keys to display the corresponding content according to the key contents.

7. The defining method adapted for a keyboard as recited in claim 6, wherein the user definable keyboard is in a film shape and composed of a transparent silica gel material.

8. The defining method adapted for a keyboard as recited in claim 6, further comprising:
when the user definable keyboard is turned off, erasing the stored keyboard information.

9. The defining method adapted for a keyboard as recited in claim 6, further comprising:
when receiving the keyboard information from the computer again, erasing the stored keyboard information.
